(19) United States
(12) Patent Application Publication
(10) Pub. No.: US 2008/0308484 A1
(43) Pub. Date: Dec. 18, 2008

(54) Filtering Device for the Removal of Arsenic from Water

(75) Inventors: Pramil Chandra Deb, Maharastra (IN); Kshipra Misra, Maharastra (IN); Mohammadi Taherbhai Companywala, Maharastra (IN); Alips Srivastava, Maharastra (IN); Sanskriti Sharma, Maharastra (IN)

Correspondence Address: THE WEBB LAW FIRM, P.C., 700 KOPPERS BUILDING, 436 SEVENTH AVENUE, PITTSBURGH, PA, 15219, US

(73) Assignee: THE DIRECTOR GENERAL DEFENCE RESEARCH & DEVELOPEMENT ORGANISATION, NEW DELHI (IN)

(21) Appl. No.: 12/065,148

(22) PCT Filed: Aug. 29, 2005
(86) PCT No.: PCT/IN2005/000286

§ 371 Date: Jul. 30, 2008

(51) Int. Cl. B01D 24/00

(52) U.S. Cl. 210/257.1; 210/170.07; 210/266; 210/335; 210/473

(57) ABSTRACT

A filtering device for the removal of arsenic from the ground water/surface water. The filtering device of the present invention uses steel wool and sand as the raw material for the removal of arsenic from water and the entire outer body of the device can be made from cheaper material like plastic material or stainless steel. The filtering device works on the simple principle of co-precipitation of arsenic with metals, followed by adsorption and filtration through treated sand. The metal, steel wool, used in the device is a processed waste generated from a steel plant thereby making the device extremely cheaper and versatile. In the filtering device of the present invention, iron arsenate and iron arsenite are co-precipitated by the reaction of steel wool with arsenic in water. The device uses treated river sand simultaneously for the removal of iron leached out during reaction.

### FILED OF INVENTION

This invention relates to a filtering device for removal of Arsenic from the contaminated ground/surface drinking water.

### PRIOR ART

Arsenic poisoning of ground/surface water presently adversely affects the huge population of several countries including India, Bangladesh, Argentina, Mexico, Chile, Mongolia, Vietnam etc. Arsenic poisoning of ground/surface water is a serious health hazard and it affects approximately 90 million people at global level. The magnitude of the problem of Arsenic poisoning has reached such proportion in India, Bangladesh and Vietnam that it needs immediate attention. There is a need for a suitable filtering device filtering device for removal of Arsenic from the ground/surface water which can be used at household level and which is within the economic reach of ordinary households. The device must be simpler, cheaper and easy to use requiring cheaper and easily available raw materials.

A number of techniques/devices, for the removal of Arsenic from drinking water, have been reported and are known to the prior art. These techniques/devices basically work on the principles of co-precipitation, coagulation, adsorption, use of ion exchange resin and reverse osmosis membranes and are mainly for community type treatment systems.

One of the process for the removal of Arsenic from drinking water, known in the prior art, is by using activated alumina. However, this process suffers from many disadvantages.

The primary disadvantages of this process, known in the art, is that it does not remove Arsenic to the desired level and prescribed for drinking water and has better removal for Arsenic (V) as compared to Arsenic (III), the latter being four times more toxic. Furthermore, it cannot be reused without alkali washing.

Another process for the removal of Arsenic from drinking water, known in the prior art, is by using chemically treated alumna. However, this process also suffers from many disadvantages.

Primary disadvantage of this process, known in the art, is that it does not remove Arsenic to the desired drinking water limit. Further limit. Further, this process leaches other harmful chemicals in the water and is an expensive process.

Yet another Arsenic removing filter, known in the prior art, uses ceramic filters. However, this filter is expensive and is not very effective for complete removal of Arsenic and more particularly for the removal of Arsenic (III).

Still another type of Arsenic removing filter, known in the prior art, uses iron and manganese oxide coated sand. However, this filter also suffers from the disadvantage that it leaches iron and manganese in drinking water, which is undesirable.

Another type of Arsenic removing technique, known in prior art, is based on ultra violet oxidation of Arsenic followed by sedimentation and filtration. The main disadvantage of this technique is that it removes only eighty percent of Arsenic from the contaminated water, which is not sufficient.

Another Arsenic removal technique at the household level, known to the prior art, includes use of iron tablets for co-precipitation of Arsenic followed by filtration through candles made-up of clay and carbon powder. However, this technique also suffers from the problems faced in cleaning of candles and disposing off the sludge. Further, the technique is also not cost effective.

U.S. Pat. No. 6,132,623 discloses the use of mixture of iron scrap and quartz sand in a reactor for in-situ treatment of Arsenic contaminated ground water. However, this technique also suffers from the disadvantage that it is not suitable for removal of Arsenic from water at household level.

### OBJECTS OF THE INVENTION

Primary object of the invention is to provide a filtering device for the removal of Arsenic from water, particularly from contaminated ground/surface water.

Another object of the invention is to provide a filtering device for the removal of Arsenic from water which can be used at household level.

Further object of the invention is to provide a filtering device for the removal of Arsenic from water which uses steel wool prepared from waste generated in steel industry in combination with treated river sand for the filtering of Arsenic.

Yet another object of the invention is to provide a filtering device for the removal of Arsenic from water wherein both the forms of Arsenic viz. Arsenic (III) and Arsenic (V) are removed completely or brought down to the desired permissible limit of drinking water.

Still another object of the invention is to provide a filtering device for the removal of Arsenic from water, which is extremely cheaper and affordable at household levels.

Yet further object of the invention is to provide a filtering device for the removal of Arsenic from water, which works on the simple principle of co-precipitation of Arsenic with metals, followed by adsorption and filtration through treated sand.

Still another object of the present invention is to provide a filtering device for the removal of Arsenic from water which is environment friendly and wherein the leaching of harmful chemicals is eliminated.

Yet another object of the present invention is to provide a filtering device for the removal of arsenic from water which can be made from cheaper materials such as plastic and stainless steel.

Still further object of the invention is to provide a filtering device for the removal of arsenic from water which utilizes cheap raw materials (steel wool and sand) for the removal of arsenic thereby making the device cheaper and affordable.

Yet further object of the invention is to provide a filtering device for the removal of arsenic from water wherein the steel wool, the raw material used can be obtained from steel plant as waste technology and which is available in plenty at low price.

### DESCRIPTION OF INVENTION

According to this invention there is provided a filtering device for the removal of arsenic from grounds/surface drinking water comprising
(i) a first chamber having steel wool disposed therein, said chamber having a water inlet at the upper end for receiving the contaminated water;
(ii) a second chamber having treated sand therein and connected at the upper end to said first chamber, the said second chamber having fine cloth filters and placed at the upper end and bottom end respectively;

Yet another object of the present invention is to provide a filtering device for the removal of arsenic from water which can be made from cheaper materials such as plastic and stainless steel.

Still further object of the invention is to provide a filtering device for the removal of arsenic from water which utilizes cheap raw materials (steel wool and sand) for the removal of arsenic thereby making the device cheaper and affordable.

Yet further object of the invention is to provide a filtering device for the removal of arsenic from water wherein the steel wool, the raw material used can be obtained from steel plant as waste technology and which is available in plenty at low price.

### DESCRIPTION OF INVENTION

According to this invention there is provided a filtering device for the removal of arsenic from grounds/surface drinking water comprising
(i) a first chamber having steel wool disposed therein, said chamber having a water inlet at the upper end for receiving the contaminated water;
(ii) a second chamber having treated sand therein and connected at the upper end to said first chamber, the said second chamber having fine cloth filters and placed at the upper end and bottom end respectively;
(iii) a third chamber connected at the upper end to said second chamber for collection of pure filtered water from the said second chamber said third chamber having a water outlet for filtered water.

The filtering device of the present invention is capable of removing both forms of arsenic viz. arsenic (III) and arsenic (V) from the ground/surface drinking water and bringing its level down to the permissible limit of drinking water. The device is completely environment friendly wherein the leaching of harmful chemicals are eliminated. The raw materials used i.e. steel wool and treated sand are easily and cheaply available thereby making the device quite affordable and within the economic reach of ordinary households. Further the device is simpler to use thus suitable for households.

Any further characteristics, advantages and applications of the invention will become evident from the detailed description of the preferred embodiment which has been described and illustrated with the help of following drawings wherein.

### DESCRIPTION OF THE ACCOMPANYING DRAWINGS

FIG. 1 shows a view of the filtering device of the present invention.

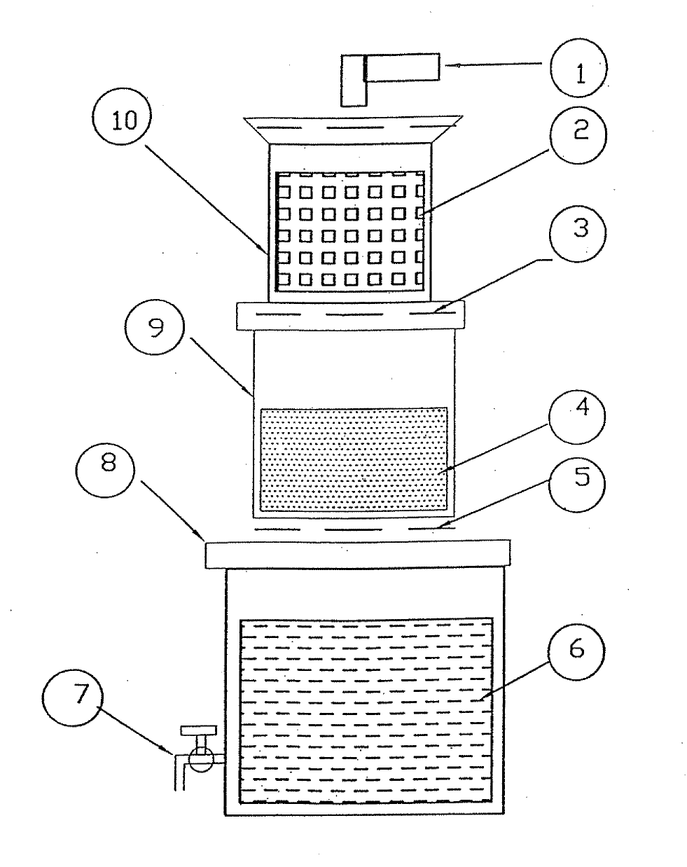

Referring to FIG. 1, The filtering device of the present invention comprising three chambers (8), (9) & (10). The first chamber (10) contains steel wool (2) soaked in water. The steel wool (2) is prepared from waste generated by steel plant. Steel wool, received as waste material from the steel plant is thoroughly washed with water to remove any contaminants already present before use in the filtering device. The second chamber (9) contains treated river sand (4). The river sand (4) is washed, air-dried and treated with KMnO₄ before putting it in the second chamber (9). A fine cloth filter (3) is placed on top of the sand to filter the precipitate particles and avoid contamination in sand. Similarly, a fine cloth filter (5) is placed at the bottom of this chamber. Quantity of steel wool (2) and treated sand (4) is about 400 grams and 1200 grams respectively. The quantity of steel wool (2) and sand (4) can be optimized for >99% removal of all types of Arsenic compounds in water under continuous flow conditions. In the first chamber (10), iron arsenate and iron arsenite are co-precipated by the reaction of steel wool (2) with Arsenic in water. The treated river sand (4), present in the second chamber (9), simultaneously removes iron leached out during the above reaction. The outer body including three chambers (10), (9) and (8) of the filtering device can be made from meta or non-metals including stainless steel and plastic.

The contaminated water is placed in the top chamber (10) through the water inlet (1). The water is allowed to flow at an optimized constant flow at the level between 15 liters/hour and 30 liters/hour. The pH value of the mixture is between 6-10. The contaminated water passes from the first chamber (10) to the second chamber (9) through steel wool (2) and fine cotton cloth (3). This partially filtered water again passes to the third chamber (7) through treated river sand (4) and fine cloth filter (5). The third chamber (8) contains the pure water (6), free from Arsenic and other undesirable contaminants specially Iron, Coliforms and E. coli., which can be taken out through an outlet (7) placed at the bottom of third chamber (8).

The filter device operates at the ambient room temperature. Total volume of water filtered depends upon the initial concentration of Arsenic in water. The life of the filtering material i.e. steel wool depends upon the initial concentration of the contaminants (Arsenic (III) and Arsenic (V)) as well as upon the total volume of the water filtered through the filtering device. Typically, in a household using 20-25 liters of water per day, the steel wool shall need replacement after one month. However, the expenditure involved will be about Rs.25/only making the device extremely cheaper and well within the economic reach of the average household even in Asian countries.

The metal ion concentration estimation of steel wool and sand samples was carried out using Phillips X-ray Fluorescence (XRF), and surface area was measured using Micromeritics ASAP 2010 Surface Analyzer. Main characteristics of the materials used therein are given below:

Characteristics of Sand and Steel wool

| | | | | | | | Surface |
|---|---|---|---|---|---|---|---|
| | pH | pH | | | | | Area |
| | (in | (in As | | | | | (BET) |
| Adsorbent | Water) | sol.) | Fe (%) | Al (%) | Mn (%) | Si (%) | M²/g |
| Sand | 10.2-10.5 | 10.2-10.5 | 8.9-10.5 | 10.5-11.0 | Not | 79.2-80.0 | 1 |
| (Yamuna) | | | | | detected | | |
| Sand | 8.3-8.5 | 7.5-8.0 | 4.7-5.0 | 11.5-12.0 | Not | 79.8-80.0 | 4 |
| (Ganga) | | | | | detected | | |
| Steel | 8.5-9.0 | 8.8-9.0 | 99.2-99.5 | Not | 0.40-0.45 | trace | 0.5 |
| Wool | | | | detected | | | |

In order to verify the efficacy of the filtering device of the present invention, different set of experiments were conducted. These experiments involved preparing synthetic solution of Arsenic contaminated water and then passing the synthetic solution through the filtering device to verify the efficacy of the device.

### EXAMPLE-1

In the first experiment, synthetic solution of 1:1 mixture of Arsenics (III) & Arsenic (V) part per million total concentration) was prepared in water and stored. This synthetics solution was passed at a flow rate of 15 liters/hour through the first chamber containing 500 grams of steel wool, followed by filtration though second chamber containing 1500 grams of treated sand. The water filtered through sand was stored in the lower most chamber and was free from Arsenic and other undesirable contaminants. The details of actual quantities of steel wool, and treated river sand required for the filtering and optimization of flow rate are shown below.

| | | |
|---|---|---|
| 1. | Steel wool (Steel plant waste) | 500 gms |
| 2. | Treated Sand | 1500 gms |
| 3. | Flow rate | 15 lit./hr |
| 4. | Initial Arsenic conc. Range | 1 ppm (1:1 mixture of |
| | | AS(III) and AS(V)) |
| 5. | Final Arsenic s Conc. | <5 ppb(Well below EPA/ |
| | | WHO's drinking water limit |
| | | of 10 parts per billion) |
| 6. | Volume of water treated | 750 lits. |
| 7. | Quality of water | Suitable for drinking |
| | | purpose. |
| 8. | Leaching of other metals | No leaching detected. |

### EXAMPLE-2

In the second such experiment, synthetic solution of 1:1 mixture of Arsenic (III) & Arsenic (V) (1 parts per million total concentration) was prepared in water and stored in reservoir. This solution was passed at the flow rate of 30 liters/hour through the first chamber containing 1000 grams of steel wool followed by filtration though second chamber containing 3000 grams of washed and air-dried sand. The water filtered through sand was stored in the lower most chamber which was free from Arsenic and other undesirable contaminants. The details of actual quantities of steel wool, and treated river sand required for the filtering and optimization of flow rate are shown below.

| | | |
|---|---|---|
| 1. | Adsorbent (Steel plant waste) | 1000 gms |
| 2. | Treated Sand | 3000 gms |
| 3. | Flow rate | 30 lit./hr |
| 4. | Initial As conc. Range | 1 ppm (1:1 mixture of |
| | | AS(III) and AS(V)) |
| 5. | Final As Conc. | <3 ppb(Well below EPA/ |
| | | WHO's drinking water limit |
| | | of 10 part per billion) |
| 6. | Volume of water treated | 1600 lits. |
| 7. | Quality of water | Suitable for drinking |
| | | purpose. |
| 8. | Leaching of other metals | No leaching |

The arsenic concentration before and after the filtering was determined as per ASTM method using GBC-HG-3000 Atomic Absorption Spectrophotometer (AAS). Results were also confirmed at School of Environmental Studies, Jadavpur University, Kolkata, which is a WHO recognized center for Arsenic analysis in India.

The analysis of the filtered water was carried out to test the efficacy of the filtering device. Results of water analysis to prove the quality of water treated using aforesaid technology are given below.

Results of Water Analysis

| | | Arsenic Conc | | | | E. Coil | |
|---|---|---|---|---|---|---|---|
| | | (xg/L) | | Iron Conc.(mg/L) | | Count/lit/hr | |
| | | | After Treatment | | After Treatment | | After Treatment |
| | Sol | | (Final drinking | | (Final drinking | | (Final drinking |
| Sl. No | Type | Initial | water | Initial | water | Initial | water |
| 1 | AS(III) | 1000 | <03 | Not | <0.3 | | 0 |
| | | | | Detected | | | |
| 2 | As(V) | 1050 | <03 | Not | <0.3 | | 0 |
| | | | | Detected | | | |
| 3 | Mixture of | 1025 | <03 | Not | <0.3 | | 0 |
| | As(III) and | | | Detected | | | |
| | AS(V) in the | | | | | | |
| | ratio of 1:1 | | | | | | |

The precipitate formed during treatment, waste material and used sand was disposed off in the form of non-leachable cement matrix by mixing with cement (grey or white) in 1:2 ratio. This matrix is impermeable in nature and can be used as concrete blocks in construction industry resulting in no waste generation in the process and making the technology environment friendly and green. Leaching tests performed in the laboratory for the cement matrix have given nil leaching in terms of Arsenic and Iron. Results are given below.

Results Of Leaching Tests Of Cement Matrix

| Acidic Condition | | Alkaline Condition | |
|---|---|---|---|
| As Conc. | Fe Conc. | As Conc. | Fe Conc. |
| Below Detection | Below Detection | Below Detection | Below |
| Limit | Limit | Limit | Detection Limit |

It is clear from the foregoing description and the analytical data as described above, the filtering device of the present invention for Arsenic removal is suitable for the treatment of drinking water at household level in Arsenic-affected areas. In addition it is very cost-effective, easy-to-use and environment friendly as the spent material can be reused for making standard grade concrete blocks.

The present embodiment of the invention, which has been set forth above, was for the purpose of illustration and is not intended to limit the scope of the invention. It is to be understood that various changes; adaptations and modifications can be made in the invention described above by those skilled in the art without departing from the scope of the invention, which has been defined by following claims.

1-6. (canceled)

7. A filtering device for the removal of arsenic from grounds/surface drinking water comprising:
(i) a first chamber having steel wool disposed therein, said chamber having a water inlet at the upper end for receiving contaminated water;
(ii) a second chamber having treated sand therein and connected at the upper end to said first chamber, said second chamber having fine cloth filters placed at the upper end and bottom end respectively; and
(iii) a third chamber connected at the upper end to said second chamber for collection of pure filtered water from said second chamber, said third chamber having a water outlet for filtered water.

8. The filtering device as claimed in claim 7, wherein said steel wool is 99.2-99.5% iron.

9. The filtering device as claimed in claim 7, wherein the quantity of said steel wool and said treated sand allows a complete removal of arsenic from the ground/surface water.

10. The filtering device as claimed in claim 7, wherein said treated sand comprises air treated and KMnO₄ treated river sand.

11. The filtering device as claimed in claim 7, wherein said first chamber, said second chamber and said third chamber are made from metal or non-metal including stainless steel and plastic.
